(19) United States
(12) Patent Application Publication
(10) Pub. No.: US 2023/0316818 A1
(43) Pub. Date: Oct. 5, 2023

(54) DATA COLLECTOR, METHOD FOR DATA COLLECTION, DATA TRANSMITTER, AND METHOD FOR DATA TRANSMISSION

(71) Applicant: TOYOTA JIDOSHA KABUSHIKI KAISHA, Toyota-shi (JP)

(72) Inventor: Masahiro Tanaka, Edogawa-ku (JP)

(21) Appl. No.: 18/176,550

(22) Filed: Mar. 1, 2023

(30) Foreign Application Priority Data
Apr. 4, 2022 (JP) 2022-062591

(51) Int. Cl. G07C 5/00; G07C 5/08

(52) U.S. Cl. CPC G07C 5/008; G07C 5/085; G07C 5/0816

(57) ABSTRACT

A data collector calculates, for each of vehicles, a score indicating the quality of data representing the surroundings of the vehicle obtained by a sensor mounted on the vehicle; stores the score in a memory; and requests vehicles, of the vehicles that have traveled through a predetermined region, to transmit the data obtained in the region when an expected number of pieces of data expected for the case where the data is collected from all of the vehicles that have traveled through the region is greater than a desired number of pieces of data preset for the region. The requested vehicles rank higher than a rank corresponding to the ratio of the desired number to the expected number in a distribution of the score stored in the memory for each of the vehicles.

### FIELD

The present disclosure relates to a data collector, a method for data collection, a computer program for data collection, a data transmitter, a method for data transmission, and a computer program for data transmission, related to data obtained by a sensor mounted on a vehicle.

### BACKGROUND

A known map-generating device collects data obtained by a sensor mounted on a vehicle from the vehicle and generates a high-precision map with the collected data. The generated high-precision map is used for autonomous driving control of a vehicle.

Japanese Unexamined Patent Publication No. 2017-194915 (hereafter “Patent Literature 1”) describes a system for collecting information on surroundings (hereafter “surrounding information”) configured to request transmission of surrounding information from a vehicle that obtains surrounding information whose accuracy is higher than a predetermined threshold. An object of the system described in Patent Literature 1 is to reduce communication traffic required to collect surrounding information by limiting targets from which surrounding information is collected.

### SUMMARY

The number of pieces of data to be collected from vehicles differs from place to place, depending on conditions such as topographic features around roads and traffic volume. It is desirable to collect an appropriate number of pieces of data from vehicles for each area including a road traveled by the vehicles and to reduce communication traffic between the vehicles and a server.

It is an object of the present disclosure to provide a data collector and a data transmitter that can reduce communication traffic between vehicles and a server when data obtained by a sensor mounted on each vehicle is collected from the vehicles.

A data collector according to the present disclosure includes a processor configured to calculate, for each of vehicles, a score indicating the quality of data representing the surroundings of the vehicle obtained by a sensor mounted on the vehicle and store the score in a memory. The processor of the data collector further requests vehicles, of the vehicles that have traveled through a predetermined region, to transmit the data obtained in the region when an expected number of pieces of data expected for the case where the data is collected from all of the vehicles that have traveled through the region is greater than a desired number of pieces of data preset for the region. The requested vehicles rank higher than a rank corresponding to the ratio of the desired number to the expected number in a distribution of the score stored in the storage unit for each of the vehicles.

In the data collector according to the present disclosure, the processor, at calculating the score, preferably calculates the score for each of the vehicles so that the score increases with the accuracy of position determination by a position determining sensor included in the vehicle.

In the data collector according to the present disclosure, the processor, at calculating the score, preferably calculates the score for each of the vehicles so that the score is higher as an environmental camera for obtaining an environmental image representing the surroundings of the vehicle is mounted higher.

In the data collector according to the present disclosure, the processor, at calculating the score, preferably calculates the score for each of the vehicles so that the score is lower as the time elapsed from manufacture of the vehicle is longer.

In the data collector according to the present disclosure, the processor, at requesting transmission of the data, preferably requests each of the vehicles to transmit information indicating a speed correction value for making a correction so that vehicle speed data obtained by a vehicle speed sensor indicates an actual vehicle speed; and at calculating the score, preferably calculates the score so that the score of a vehicle whose speed correction value is outside a speed correction range is lower than the score of a vehicle whose speed correction value is within the speed correction range.

In the data collector according to the present disclosure, the processor, at request transmission of the data, preferably transmits, to each of the vehicles, a score map indicating that for each of the vehicles transmission of the data is requested in a region where the vehicle ranks higher than a rank corresponding to the ratio of the desired number to the expected number in the distribution of the score, and that transmission of the data is not requested in a region where the vehicle ranks lower than the rank.

A method for data collection according to the present disclosure includes calculating, for each of vehicles, a score indicating the quality of data representing the surroundings of the vehicle obtained by a sensor mounted on the vehicle; storing the score in a storage unit; and requesting vehicles, of the vehicles that have traveled through a predetermined region, to transmit the data obtained in the region during an interval, when an expected number of pieces of data expected for the case where the data is collected from all of the vehicles that have traveled through the region is greater than a desired number of pieces of data preset for the region. The requested vehicles rank higher than a rank corresponding to the ratio of the desired number to the expected number in a distribution of the score stored in the storage unit for each of the vehicles.

A computer program for data collection stored in a non-transitory computer-readable medium according to the present disclosure causes a computer to execute a process including calculating, for each of vehicles, a score indicating the quality of data representing the surroundings of the vehicle obtained by a sensor mounted on the vehicle; storing the score in a storage unit; and requesting vehicles, of the vehicles that have traveled through a predetermined region, to transmit the data obtained in the region during an interval, when an expected number of pieces of data expected for the case where the data is collected from all of the vehicles that have traveled through the region is greater than a desired number of pieces of data preset for the region. The requested vehicles rank higher than a rank corresponding to the ratio of the desired number to the expected number in a distribution of the score stored in the storage unit for each of the vehicles.

A data transmitter according to the present disclosure includes a processor configured to determine a score indicating the quality of data representing the surroundings of a vehicle obtained by a sensor mounted on the vehicle. The processor of the data transmitter further obtains, from a data collector, lower-limit score information indicating a lower-limit score that a vehicle configured to transmit the data obtained during travel through a predetermined region to the data collector should have. The processor of the data transmitter further transmits the data obtained during travel through the region to the data collector via a communication device when the determined score is higher than the lower-limit score.

A method for data transmission according to the present disclosure includes determining a score indicating the quality of data representing the surroundings of a vehicle obtained by a sensor mounted on the vehicle; obtaining, from a data collector, lower-limit score information indicating a lower-limit score that a vehicle configured to transmit the data obtained during travel through a predetermined region to the data collector should have; and transmitting the data obtained during travel through the region to the data collector via a communication device when the determined score is higher than the lower-limit score.

A computer program for data transmission stored in a non-transitory computer-readable medium according to the present disclosure causes a computer to execute a process including determining a score indicating the quality of data representing the surroundings of a vehicle obtained by a sensor mounted on the vehicle; obtaining, from a data collector, lower-limit score information indicating a lower-limit score that a vehicle configured to transmit the data obtained during travel through a predetermined region to the data collector should have; and transmitting the data obtained during travel through the region to the data collector via a communication device when the determined score is higher than the lower-limit score.

The data collector and the data transmitter according to the present disclosure can reduce communication traffic between vehicles and a server when data obtained by a sensor mounted on each vehicle is collected from the vehicles.

### BRIEF DESCRIPTION OF DRAWINGS

FIG. 1 schematically illustrates the configuration of a data collecting system.

FIG. 2 illustrates the hardware configuration of a data collector.

FIG. 3 is a functional block diagram of a processor included in the data collector.

FIG. 4 illustrates an example of a score calculated for each of vehicles.

FIG. 5 illustrates an example of desired numbers and expected numbers of pieces of data of respective regions.

FIG. 6 illustrates an example of a score distribution.

FIG. 7 is a flowchart of a data collection process.

FIG. 8 schematically illustrates the configuration of a vehicle equipped with a data transmitter.

FIG. 9 illustrates the hardware configuration of the data transmitter.

FIG. 10 is a functional block diagram of a processor included in the data transmitter.

FIG. 11 is a flowchart of a data transmission process.

### DESCRIPTION OF EMBODIMENTS

A data collector and a data transmitter will now be described in detail with reference to the attached drawings. The data collector calculates, for each of vehicles, a score indicating the quality of data representing the surroundings of the vehicle obtained by a sensor mounted on the vehicle and stores the score in a storage unit. The data collector requests vehicles, of the vehicles that have traveled through a predetermined region, to transmit the data obtained in the region when an expected number of pieces of data is greater than a desired number of pieces of data. The requested vehicles rank higher than a rank corresponding to the ratio of the desired number to the expected number in a distribution of the score stored in the storage unit for each of the vehicles. The expected number is the number of pieces of data expected for the case where the data is collected from all of the vehicles that have traveled through the region, and the desired number is the number of pieces of data preset for the region. The data transmitter determines a score indicating the quality of data representing the surroundings of a vehicle obtained by a sensor mounted on the vehicle. The data transmitter obtains, from the data collector, lower-limit score information indicating a lower-limit score that a vehicle configured to transmit the data obtained during travel through a predetermined region to the data collector should have. The data transmitter transmits the data obtained in the region to the data collector via a communication device when the determined score is higher than the lower-limit score.

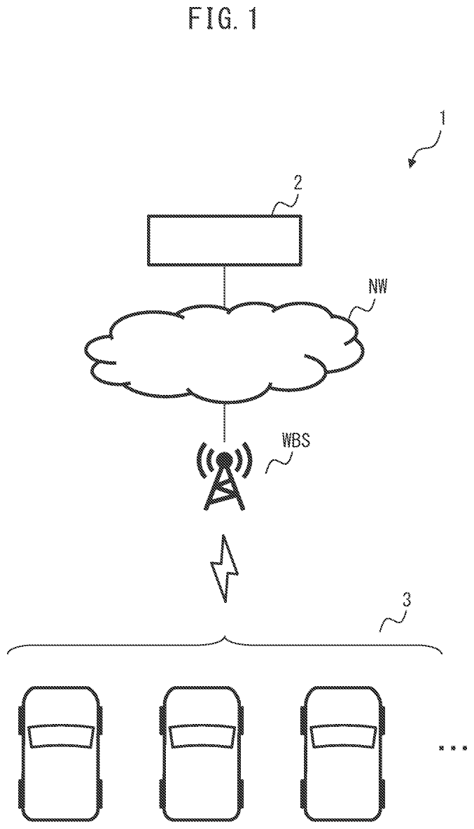

FIG. 1 schematically illustrates the configuration of a data collecting system. In the present embodiment, the data collecting system 1 includes a data collector 2 and multiple vehicles 3 each equipped with a data transmitter. Each of the vehicles 3 accesses a wireless base station WBS, which is connected, for example, via a gateway (not illustrated) to a communication network NW connected with the data collector 2, thereby connecting to the data collector 2 via the wireless base station WBS and the communication network NW. In the following, one of the vehicles 3 will be referred to as “a vehicle 3.” In the data collecting system 1, the communication network NW may be connected with multiple wireless base stations WBS.

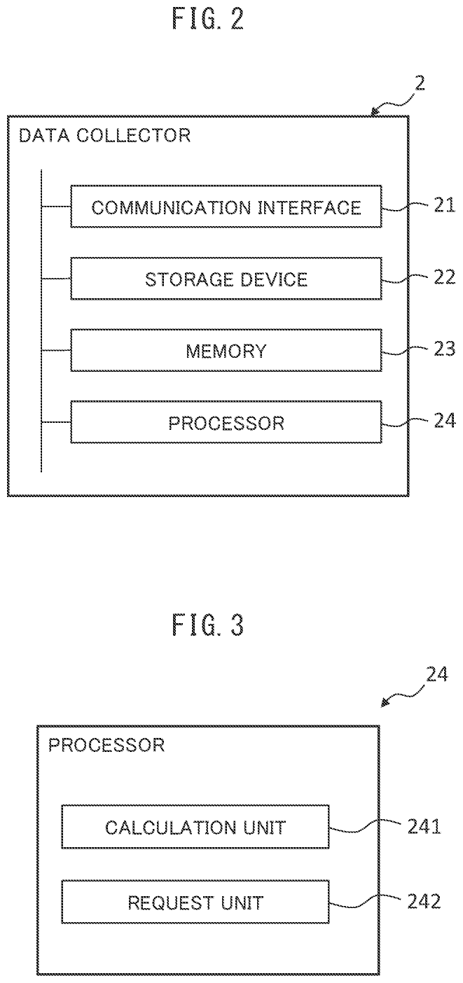

FIG. 2 illustrates the hardware configuration of the data collector 2. The data collector 2 includes a communication interface 21, a storage device 22, a memory 23, and a processor 24.

The communication interface 21, which is an example of a communication unit, includes an interface circuit for connecting the data collector 2 to the communication network NW. The communication interface 21 is configured to be communicable with another device via the communication network NW. More specifically, the communication interface 21 passes, to the processor 24, data received from a device via the communication network NW, and transmits data received from the processor 24 to a device via the communication network NW.

The storage device 22, which is an example of a storage unit, includes storage, such as a hard disk drive or a nonvolatile semiconductor memory. For each of the vehicles 3, the storage device 22 stores a score indicating the quality of data representing the surroundings of the vehicle obtained by a sensor mounted on the vehicle. For each of regions, the storage device 22 stores an expected number of pieces of data expected for the case where data is collected from all of the vehicles 3 that have traveled through the region, and a desired number of pieces of data for the region. The storage device 22 stores data collected from the vehicles 3.

The memory 23, which is another example of a storage unit, includes volatile and nonvolatile semiconductor memories. The memory 23 temporarily stores various types of data used for processing by the processor 24, such as data received via the communication interface 21. In addition, the memory 23 stores various application programs, such as a data collection program for collecting data from the vehicles 3.

The processor 24 includes one or more central processing units (CPUs) and a peripheral circuit thereof. The processor 24 may further include another operating circuit, such as a logic-arithmetic unit or an arithmetic unit.

FIG. 3 is a functional block diagram of the processor 24 included in the data collector 2.

As its functional blocks, the processor 24 of the data collector 2 includes a calculation unit 241 and a request unit 242. These units included in the processor 24 are functional modules implemented by a computer program executed by the processor 24. The computer program for achieving the functions of the units of the processor 24 may be provided in a form recorded on a computer-readable portable storage medium, such as a semiconductor memory, a magnetic medium, or an optical medium. Alternatively, the units included in the processor 24 may be implemented in the data collector 2 as separate integrated circuits, microprocessors, or firmware.

The calculation unit 241 calculates, for each of the vehicles 3, a score indicating the quality of data representing the surroundings of the vehicle obtained by a sensor mounted on the vehicle, and stores the score in the storage device 22. Examples of the data representing the surroundings of the vehicle includes an image of the surroundings obtained by a camera and a range image of the surroundings obtained by a light detection and ranging (LiDAR) sensor or a radio detection and ranging (RADAR) sensor. Alternatively, the data representing the surroundings of the vehicle may be information on surrounding features detected from output of these sensors.

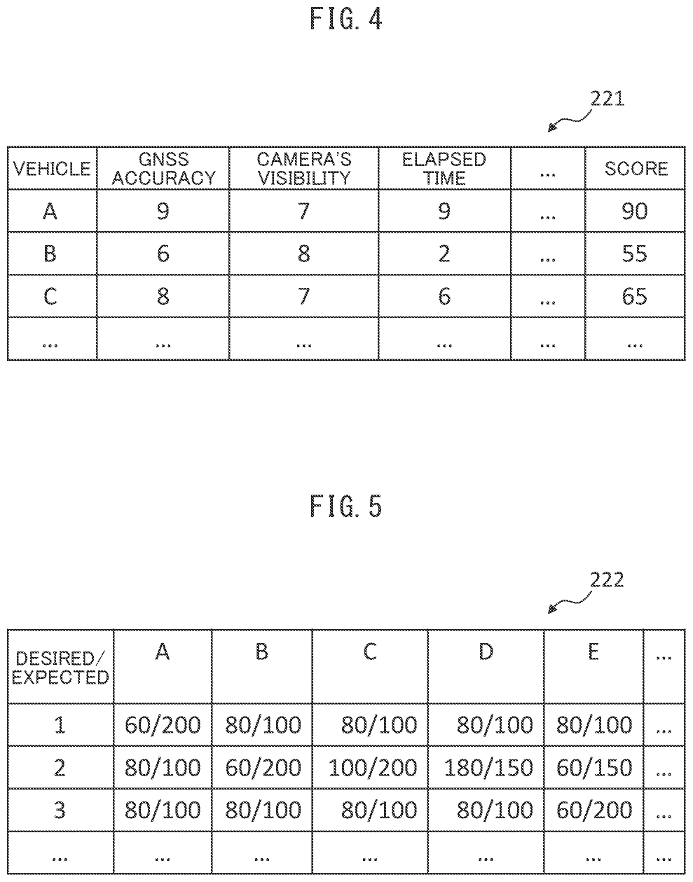

FIG. 4 illustrates an example of the score calculated for each of the vehicles 3.

As illustrated in a table 221, the calculation unit 241 calculates a score for each vehicle, based on ratings for items such as GNSS (global navigation satellite system) accuracy, camera's visibility, and elapsed time. First, the calculation unit 241 refers to a database server (not illustrated) capable of communicating with the data collector 2 via the communication network NW to determine the ratings for the respective items. The database server stores, for each vehicle, detailed vehicle information including information on the type of GNSS receiving system mounted on the vehicle, the mounted position of an environmental camera, and the date of manufacture, in association with an identification number of the vehicle. Subsequently, the calculation unit 241 substitutes the determined ratings for the respective items into a predetermined mathematical expression to calculate the score. The ratings for the respective items and the expression for calculating the score are set so that the score increases with the quality of data. The calculation unit 241 stores the calculated score in the storage device 22.

The GNSS accuracy is the accuracy of position determination by a GNSS receiving system (GNSS antenna and GNSS receiver) included in the vehicle. The GNSS receiving system is an example of the position determining sensor. The rating for GNSS accuracy is set higher as the accuracy of position determination by the GNSS receiving system included in the vehicle is higher, based on the type and the manufacturer of the GNSS antenna and the GNSS receiver identified from the model of the vehicle by referring to the database server.

The rating for camera's visibility is calculated as a function of the height of the mounted position of an environmental camera, which is an example of a sensor for obtaining an environmental image as data representing the surroundings of the vehicle 3. If the camera is mounted too low, light from a detection target, such as a white line on the road, enters the image surface of its focusing optical system at a small angle, which makes it difficult to detect the detection target accurately. The calculation unit 241 calculates the rating for camera's visibility so that the rating is lower as the difference between the height of the mounted position of the camera of the vehicle obtained by referring to the database server and a predetermined ideal height of the mounted position of the camera is greater.

The elapsed time is the time elapsed from manufacture. An older vehicle is subjected to greater vibration, roll, and pitch, which lowers the quality of data obtained by a sensor. The calculation unit 241 may calculate the rating for elapsed time, based on, for example, the time elapsed since registration of the identification number of the vehicle obtained by referring to the database server.

The calculation unit 241 may calculate the score for each of the vehicles 3, using a value related to data obtained by the vehicle. In this case, the request unit 242 requests each of the vehicles 3 to transmit the value related to data obtained by the vehicle via the communication network NW, and stores the received value in the storage device 22. The calculation unit 241 calculates the score by referring to the ratings for the respective items stored in the storage device 22.

For example, the request unit 242 requests each of the vehicles 3 to transmit dilution of precision (DOP) or the number of captured satellites, which are recorded in chronological order at a particular place. For each of the vehicles 3, the calculation unit 241 corrects the rating for GNSS accuracy, which is set on the basis of the GNSS receiving system included in the vehicle, using a value calculated by substituting the DOP or the number of captured satellites received from the vehicle into an expression representing the relationship between the DOP or the number of captured satellites and the GNSS accuracy, and stores the corrected rating in the storage device 22. The calculation unit 241 may set the rating for GNSS accuracy for each of the vehicles 3, using the DOP or the number of captured satellites received from the vehicle, without referring to the GNSS receiving system included in the vehicle.

For example, the request unit 242 requests each of the vehicles 3 to transmit information as to whether the mounted position of the camera is changed after shipment, for example, by conversion of the vehicle. The calculation unit 241 makes a correction to lower the rating for camera's visibility of a vehicle in which the mounted position of the camera is changed after shipment, and stores the rating in the storage device 22.

For example, the request unit 242 requests information on total mileage from each of the vehicles 3. The calculation unit 241 corrects the rating for elapsed time so that the rating of a vehicle is lower as its total mileage is longer, and stores the rating in the storage device 22. The calculation unit 241 may set the rating for elapsed time for each of the vehicles 3, using the total mileage received from the vehicle, without referring to the time elapsed since registration of the identification number of the vehicle.

The calculation unit 241 may calculate the score, using a rating for a speed correction value. The speed correction value is a value for making a correction so that vehicle speed data obtained by a vehicle speed sensor indicates an actual vehicle speed. The accuracy of position determination is lower as the speed correction value is larger. The rating for the speed correction value of a vehicle whose speed correction value is outside a speed correction range (exceeds an upper limit) is set lower than the rating of a vehicle whose speed correction value is within the speed correction range (does not exceed the upper limit). The rating for the speed correction value may be set on the basis of time-varying changes in the speed correction value. For example, when the difference between a newly obtained speed correction value and the last obtained speed correction value is greater than a predetermined correction threshold, the rating for the speed correction value is set low. The calculation unit 241 obtains the speed correction value from the vehicle 3 via the communication network NW, calculates the rating for the speed correction value, and stores the rating in the storage device 22.

Referring back to FIG. 3, the request unit 242 requests vehicles, of the vehicles 3 that have traveled through a predetermined region, to transmit the data obtained in the region when an expected number of pieces of data is greater than a desired number of pieces of data. The requested vehicles rank higher than a rank corresponding to the ratio of the desired number to the expected number in a distribution of the score stored in the storage device 22 for each of the vehicles 3.

FIG. 5 illustrates an example of desired numbers and expected numbers of pieces of data of respective regions.

As illustrated in a table 222, a map is maintained by being divided into regions of a predetermined size. The vertical and horizontal directions of the table 222 correspond to a north-south direction and an east-west direction, respectively. For each region (e.g., A1 and B2), the storage device 22 stores an expected number and a desired number of pieces of data in association with the region. The expected number and the desired number may be set as numbers per predetermined interval (e.g., a day).

The expected number is the number of pieces of data expected for the case where the data is collected from all of the vehicles 3 that have traveled through the region. The expected number of pieces of data is estimated, for example, on the basis of the average number of vehicles that travel through the region per unit time and the number of collected pieces per unit time in the past data collection.

The desired number is a target number of pieces of data to be collected for the corresponding region in a predetermined interval, and is preset by an administrator of the data collector.

In region A1 of the example illustrated in the table 222, the desired number and the expected number of pieces of data are 60 and 200, respectively. In region B2, the desired number and the expected number of pieces of data are 80 and 100, respectively.

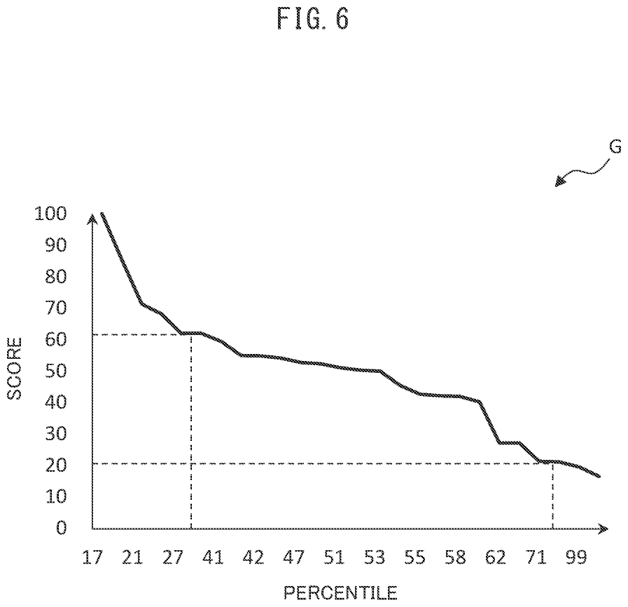

FIG. 6 illustrates an example of a score distribution. The graph G represents the distribution of the scores of the vehicles 3.

The ordinate and the abscissa of the graph G represent the score and the percentile rank, respectively. More specifically, when the scores of the vehicles 3 are arranged in descending order, for example, a vehicle with a score of 62 ranks in the top 30%, and a vehicle with a score of 21 ranks in the top 80%.

In the example of FIG. 5, in region D2 the expected number of pieces of data is less than the desired number of pieces of data whereas in the other regions the expected number of pieces of data is greater than the desired number of pieces of data. Thus the request unit 242 requests all of the traveling vehicles 3 to transmit data obtained in region D2. For each of the other regions, the request unit 242 requests transmission of data obtained in the region from vehicles, of the traveling vehicles 3, ranking higher than a rank corresponding to the ratio of the desired number to the expected number in the distribution of the scores of the vehicles.

For example, in region A1, the ratio of the desired number to the expected number is 60/200=30%. The request unit 242 requests transmission of data obtained in region A1 from vehicles ranking in score higher than the 30 percentile rank, i.e., vehicles with a score of 62 or higher.

Similarly, in region B2, the ratio of the desired number to the expected number is 80/100=80%. The request unit 242 requests transmission of data obtained in region B2 from vehicles ranking in score higher than the 80 percentile rank, i.e., vehicles with a score of 21 or higher.

To collect data in a predetermined region from vehicles with a score higher than a predetermined degree, the request unit 242 generates a data collection map in which the necessity or unnecessity of data transmission is associated with each region for each of the vehicles 3, and transmits the map to the corresponding vehicle via the communication network NW. Each vehicle refers to the data collection map, and transmits data of a region where data transmission is necessary to the data collector 2 via the communication network NW.

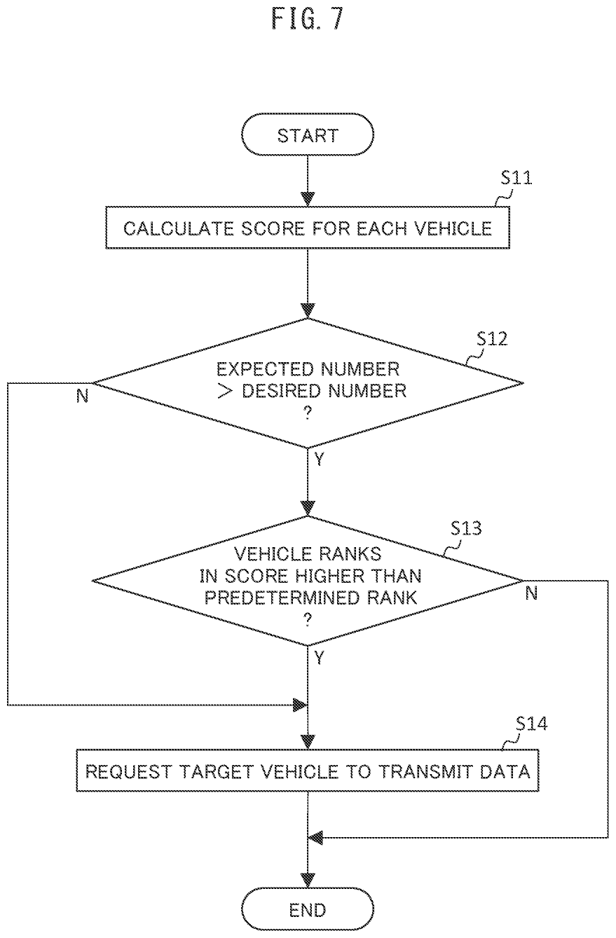

FIG. 7 is a flowchart of a data collection process. The processor 24 of the data collector 2 executes the data collection process illustrated in FIG. 7 for each vehicle a predetermined period (e.g., an hour) before a target interval for collecting data from a predetermined region.

First, the calculation unit 241 of the processor 24 calculates a score for each of the vehicles 3 (step S11). This processing can be omitted if the scores of the vehicles have been calculated in the previous data collection. Alternatively, this processing may be executed on a vehicle newly added after the previous data processing and a vehicle regarding which a certain item for calculating the score has been changed.

Subsequently, the request unit 242 determines whether the expected number of pieces of data is greater than the desired number of pieces of data in the predetermined region (step S12). When it is determined that the expected number is not greater than the desired number (No in step S12), the process proceeds to step S14 described below.

When it is determined that the expected number is greater than the desired number (Yes in step S12), the request unit 242 determines whether the vehicle ranks higher than a rank corresponding to the ratio of the desired number to the expected number in the distribution of the score (step S13). When it is determined that the rank in score is not higher than the predetermined rank (No in step S13), the request unit 242 terminates the data collection process.

When it is determined that the rank in score is higher than the predetermined rank (Yes in step S13), the request unit 242 requests the vehicle to transmit data obtained in the region (step S14) and terminates the data collection process. When data is received from a vehicle requested to transmit the data, the request unit 242 stores the data in the storage device 22 regardless of whether the data collection process has been terminated.

For each region and each vehicle, the data collector 2 executes this data collection process. The data collector may generate a data collection map by recording a region where data should be obtained from the vehicle in step S14 of the data collection process, and transmit the data collection map to the vehicle after termination of the above process, to collect data.

The data collector 2 can reduce communication traffic between vehicles and a server when data obtained by a sensor mounted on each vehicle is collected from the vehicles, by executing the data collection process in this way.

Regarding a region where low-quality data is collected, the data collector 2 may request transmission of data from vehicles ranking higher than a rank corresponding to the ratio of the desired number to the expected number in the distribution of the score. This operation enables the data collector 2 to improve the quality of collected data in a region where low-quality data is collected.

For example, data obtained during a turn or travel through a curve and data obtained when the absolute value of acceleration is large (during acceleration or deceleration) lower the accuracy of determination of the position of the vehicle. In a region including a road portion with a large curvature and a region including a place where vehicles necessarily stop, such data is often obtained, and thus the quality of collected data is low. Regarding such a region, the data collector 2 may change target vehicles for collection to vehicles ranking in score higher than a rank corresponding to the ratio of the desired number to the expected number.

According to another embodiment, the request unit 242 of the data collector 2 transmits, to the vehicles 3, lower-limit score information indicating a lower-limit score that a vehicle configured to transmit the data obtained during travel through a predetermined region to the data collector 2 should have, to collect data.

The lower-limit score corresponds to the score whose percentile rank equals the ratio of the desired number to the expected number. For example, in region A1 of FIG. 5, a score of 62, whose percentile rank equals the ratio of the desired number to the expected number, 30%, is the lower-limit score.

The request unit 242 transmits lower-limit score information indicating the lower-limit score for each region to each of the vehicles 3 via the communication network NW. The lower-limit score information indicating the lower-limit score for each region corresponds to a score map indicating that transmission of the data is requested in a region where the vehicle ranks higher than a rank corresponding to the ratio of the desired number to the expected number in the distribution of the score, and that transmission of the data is not requested in a region where the vehicle ranks lower than the rank. In the present embodiment, each of the vehicles 3 is equipped with a data transmitter configured to transmit data to the data collector 2, using the lower-limit score information.

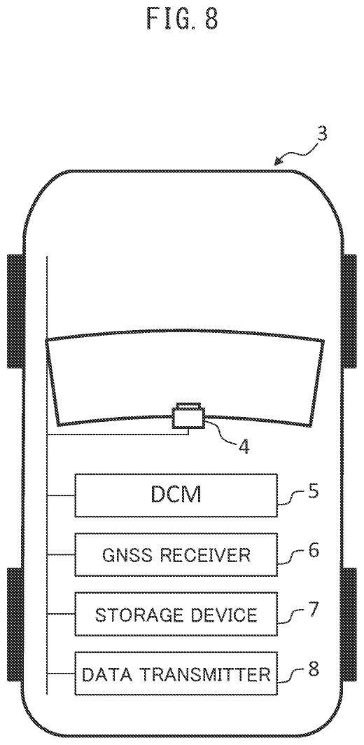

FIG. 8 schematically illustrates the configuration of a vehicle equipped with a data transmitter.

The vehicle 3 includes an environmental camera 4, a data communication module (DCM) 5, a GNSS receiver 6, a storage device 7, and a data transmitter 8. The environmental camera 4, the data communication module 5, the GNSS receiver 6, and the storage device 7 are communicably connected to the data transmitter 8 via an in-vehicle network conforming to a standard such as a controller area network.

The environmental camera 4 is an example of a sensor for generating environmental data depending on the surroundings of the vehicle 3. The environmental camera 4 includes a two-dimensional detector constructed from an array of optoelectronic transducers, such as CCD or C-MOS, having sensitivity to visible light and a focusing optical system that forms an image of a target region of capturing on the two-dimensional detector. The environmental camera 4 is disposed, for example, in a front and upper area in the vehicle interior and oriented forward. The environmental camera 4 takes pictures of the surroundings of the vehicle 3 through front and rear windshields every predetermined capturing period (e.g., 1/30 to 1/10 seconds), and outputs images representing the surroundings as the environmental data.

The data communication module 5, which is an example of the communication device, is a device to execute processing for wireless communication conforming to a predetermined wireless communication standard, such as “4G” (4th Generation) or “5G” (5th Generation). The data communication module 5 accesses, for example, the wireless base station WBS to connect to the data collector 2 via the wireless base station WBS and the communication network NW. The data communication module 5 receives a downlink radio signal from the wireless base station WBS, and passes, to the data transmitter 8, the lower-limit score information from the data collector 2 included in the radio signal. The data communication module 5 includes data received from the data transmitter 8 in an uplink radio signal, and transmits the radio signal to the wireless base station WBS, thereby transmitting data to the data collector 2. The data communication module 5 may be mounted as part of the data transmitter 8.

The GNSS receiver 6, which is an example of the position determining sensor, receives GNSS signals from GNSS satellites with a GNSS antenna (not illustrated) at predetermined intervals, and determines the position of the vehicle 3, based on the received GNSS signals. The GNSS receiver 6 outputs a positioning signal indicating the result of determination of the position of the vehicle 3 based on the GNSS signals to the data transmitter 8 via the in-vehicle network at predetermined intervals.

The storage device 7, which is an example of vehicle storage, includes, for example, a hard disk drive or a nonvolatile semiconductor memory. The storage device 7 stores a high-precision map, which includes, for example, association between locations and regions represented in the map. The storage device 7 temporarily stores environmental data outputted by the environmental camera 4 for a predetermined period. Appropriate setting of the predetermined period during which environmental data is temporarily stored in the storage device 7 enables the data transmitter 8 to transmit data appropriately, even if the lower-limit score information is obtained after a target interval for data collection.

The data transmitter 8 is an electronic control unit (ECU) including a communication interface, a memory, and a processor. The data transmitter 8 obtains the lower-limit score information via the communication interface. Further, the data transmitter 8 detects surrounding features from an environmental image generated by the environmental camera, and transmits information indicating the features as data to the data collector.

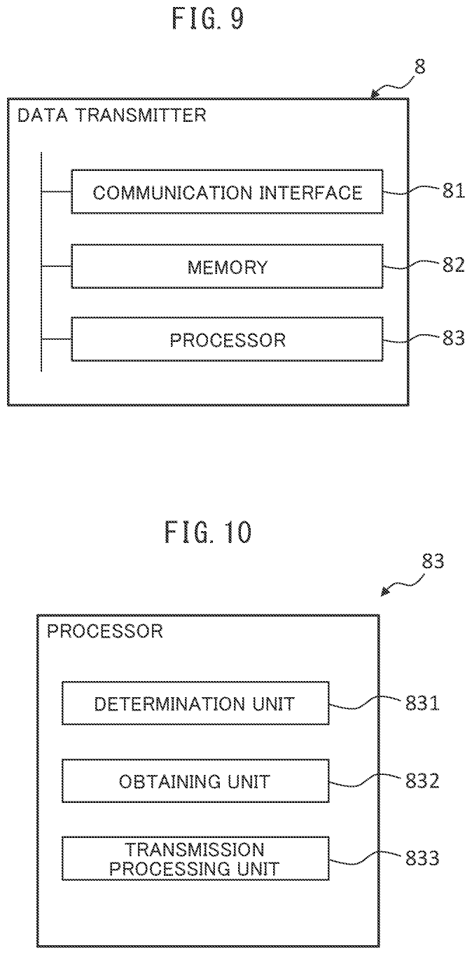

FIG. 9 illustrates the hardware configuration of the data transmitter 8. The data transmitter 8 includes a communication interface 81, a memory 82, and a processor 83.

The communication interface 81, which is an example of a communication unit, includes a communication interface circuit for connecting the data transmitter 8 to the in-vehicle network. The communication interface 81 provides received data for the processor 83, and outputs data provided from the processor 83 to an external device.

The memory 82, which is an example of a vehicle storage unit, includes volatile and nonvolatile semiconductor memories. The memory 82 stores various types of data used for processing by the processor 83. Examples of data stored in the memory 82 include the lower-limit score information obtained from the data collector 2 and the score of the vehicle 3. The memory 82 also stores various application programs, such as a computer program for data transmission for executing a data transmission process.

The processor 83, which is an example of a control unit, includes one or more processors and a peripheral circuit thereof. The processor 83 may further include another operating circuit, such as a logic-arithmetic unit, an arithmetic unit, or a graphics processing unit.

FIG. 10 is a functional block diagram of the processor 83 included in the data transmitter 8.

As its functional blocks, the processor 83 of the data transmitter 8 includes a determination unit 831, an obtaining unit 832, and a transmission processing unit 833. These units included in the processor 83 are functional modules implemented by a computer program executed by the processor 83. The computer program for achieving the functions of the units of the processor 83 may be provided in a form recorded on a computer-readable portable storage medium, such as a semiconductor memory, a magnetic medium, or an optical medium. Alternatively, the units included in the processor 83 may be implemented in the data transmitter 8 as separate integrated circuits, microprocessors, or firmware.

The determination unit 831 determines a score indicating the quality of data representing the surroundings of the vehicle 3 obtained by a sensor mounted on the vehicle. The determination unit 831 determines the score by referring to a score received from the data collector 2 via the communication network NW and stored in the memory 82. Alternatively, the determination unit 831 may identify the values of the vehicle 3 for the respective items illustrated in FIG. 4, and substitute these values into a predetermined mathematical expression to determine the score.

The obtaining unit 832 transmits a signal for requesting the lower-limit score information to the data collector 2, and obtains the lower-limit score information on a predetermined region from the data collector 2. The obtaining unit 832 stores the obtained lower-limit score information in the memory 82.

The transmission processing unit 833 transmits, when the identified score is higher than the lower-limit score, data obtained during travel through the predetermined region to the data collector 2 via the data communication module 5.

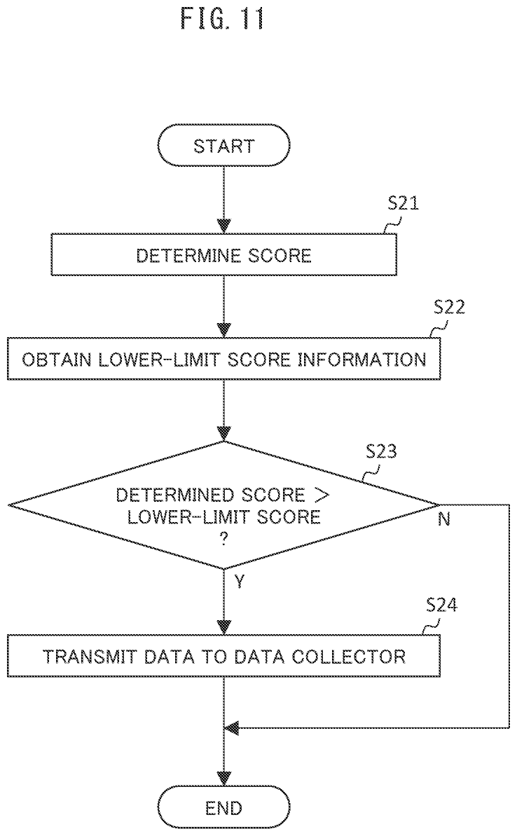

FIG. 11 is a flowchart of a data transmission process. The processor 83 of the data transmitter 8 executes the data transmission process illustrated in FIG. 11 every predetermined period (e.g., every week) set according to the amount of environmental data temporarily stored in the storage device 7 and a target interval for collecting data from a predetermined region.

The determination unit 831 of the data transmitter 8 determines the score of the vehicle 3 (step S21).

The obtaining unit 832 of the data transmitter 8 obtains the lower-limit score information on the predetermined region from the data collector 2 via the communication network NW (step S22).

The transmission processing unit 833 of the data transmitter 8 determines whether the determined score is higher than the lower-limit score (step S23). When it is determined that the determined score is not higher than the lower-limit score (No in step S23), the transmission processing unit 833 terminates the data transmission process of the region.

When it is determined that the determined score is higher than the lower-limit score (Yes in step S23), the transmission processing unit 833 transmits data obtained in the region to the data collector 2 via the data communication module 5 (step S24) and terminates the data transmission process of the region.

For each region, the data transmitter 8 executes this data transmission process.

The data transmitter 8 can reduce communication traffic between vehicles and a server when data obtained by a sensor mounted on each vehicle is collected from the vehicles, by executing the data transmission process in this way.

Note that those skilled in the art can make various changes, substitutions, and modifications without departing from the spirit and scope of the present disclosure.

What is claimed is:

1. A data collector comprising a processor configured to:
calculate, for each of vehicles, a score indicating the quality of data representing the surroundings of the vehicle obtained by a sensor mounted on the vehicle,
store the score in a memory, and
request vehicles, of the vehicles that have traveled through a predetermined region, to transmit the data obtained in the region when an expected number of pieces of data expected for the case where the data is collected from all of the vehicles that have traveled through the region is greater than a desired number of pieces of data preset for the region, the requested vehicles ranking higher than a rank corresponding to the ratio of the desired number to the expected number in a distribution of the score stored in the memory for each of the vehicles.

2. The data collector according to claim 1, wherein at calculating the score, the processor calculates the score for each of the vehicles so that the score increases with the accuracy of position determination by a position determining sensor included in the vehicle.

3. The data collector according to claim 1, wherein at calculating the score, the processor calculates the score for each of the vehicles so that the score is higher as an environmental camera for obtaining an environmental image representing the surroundings of the vehicle is mounted higher.

4. The data collector according to claim 1, wherein at calculating the score, the processor calculates the score for each of the vehicles so that the score is lower as the time elapsed from manufacture of the vehicle is longer.

5. The data collector according to claim 1, wherein
at requesting transmission of the data, the processor requests each of the vehicles to transmit information indicating a speed correction value for making a correction so that vehicle speed data obtained by a vehicle speed sensor indicates an actual vehicle speed; and
at calculating the score, the processor calculates the score so that the score of a vehicle whose speed correction value is outside a speed correction range is lower than the score of a vehicle whose speed correction value is within the speed correction range.

6. The data collector according to claim 1, wherein at requesting transmission of the data, the processor transmits, to each of the vehicles, a score map indicating that for each of the vehicles transmission of the data is requested in a region where the vehicle ranks higher than a rank corresponding to the ratio of the desired number to the expected number in the distribution of the score, and that transmission of the data is not requested in a region where the vehicle ranks lower than the rank.

7. A method for data collection, comprising:
calculating, for each of vehicles, a score indicating the quality of data representing the surroundings of the vehicle obtained by a sensor mounted on the vehicle;
storing the score in a memory; and
requesting vehicles, of the vehicles that have traveled through a predetermined region, to transmit the data obtained in the region when an expected number of pieces of data expected for the case where the data is collected from all of the vehicles that have traveled through the region is greater than a desired number of pieces of data preset for the region, the requested vehicles ranking higher than a rank corresponding to the ratio of the desired number to the expected number in a distribution of the score stored in the memory for each of the vehicles.

8. A non-transitory computer-readable medium storing a computer program for data collection, the computer program causing a computer to execute a process comprising:
calculating, for each of vehicles, a score indicating the quality of data representing the surroundings of the vehicle obtained by a sensor mounted on the vehicle;
storing the score in a memory; and
requesting vehicles, of the vehicles that have traveled through a predetermined region, to transmit the data obtained in the region when an expected number of pieces of data expected for the case where the data is collected from all of the vehicles that have traveled through the region is greater than a desired number of pieces of data preset for the region, the requested vehicles ranking higher than a rank corresponding to the ratio of the desired number to the expected number in a distribution of the score stored in the memory for each of the vehicles.

9. A data transmitter comprising a processor configured to:
determine a score indicating the quality of data representing the surroundings of a vehicle obtained by a sensor mounted on the vehicle,
obtain, from a data collector, lower-limit score information indicating a lower-limit score that a vehicle configured to transmit the data obtained during travel through a predetermined region to the data collector should have, and
transmit the data obtained during travel through the region to the data collector via a communication device when the determined score is higher than the lower-limit score.

10. A method for data transmission, comprising:
determining a score indicating the quality of data representing the surroundings of a vehicle obtained by a sensor mounted on the vehicle;
obtaining, from a data collector, lower-limit score information indicating a lower-limit score that a vehicle configured to transmit the data obtained during travel through a predetermined region to the data collector should have; and
transmitting the data obtained during travel through the region to the data collector via a communication device when the determined score is higher than the lower-limit score.

11. A non-transitory computer-readable medium storing a computer program for data transmission, the computer program causing a computer to execute a process comprising:
determining a score indicating the quality of data representing the surroundings of a vehicle obtained by a sensor mounted on the vehicle;
obtaining, from a data collector, lower-limit score information indicating a lower-limit score that a vehicle configured to transmit the data obtained during travel through a predetermined region to the data collector should have; and
transmitting the data obtained during travel through the region to the data collector via a communication device when the determined score is higher than the lower-limit score.
